(19) United States
(12) Patent Application Publication
(10) Pub. No.: US 2005/0256872 A1
(43) Pub. Date: Nov. 17, 2005

(54) Child safety ID software-data collection and data distribution program

(76) Inventors: Michael J. Childs, Fort Worth, TX (US); Matthew S. Childs, Fort Worth, TX (US)

Correspondence Address: Wilson Daniel Swayze, Jr., 3804 Clearwater Ct., Plano, TX, 75025, US

(21) Appl. No.: 10/988,738

(22) Filed: Nov. 15, 2004

Related U.S. Application Data
(60) Provisional application No. 60/520,103, filed on Nov. 14, 2003.

(51) Int. Cl. G06F 7/00

(52) U.S. Cl. 707/9

(57) ABSTRACT

A method for entering identification data of a person or pet includes forming personal information of the person or said pet, forming picture images of the person or pet, and combining the personal information and the picture image simultaneously.

### RELATED APPLICATIONS

The present application claims priority based on provisional application No. 60/520,103 filed on Nov. 14, 2003.

A compact disc ‘digikids’ and duplicate are filed with this application, and the information on the disc is incorporated by reference in its entirety. The computer data file located at the end of this application shows the size and dates of creation and directories the files. The files are compatible with Windows operating system with Microsoft Internet Browser IE 5 or higher.

### BACKGROUND

Missing children are an important problem in the world today. It is recognized that in order to successfully recover missing children, it is important to dispense identification information as quickly and as accurately as possible to law enforcement and missing children agencies. This is sometimes difficult because of the emotional strain that is placed on the parents by the situation. It can be appreciated that it is helpful to have collected the identification information before the event occurs to ensure that the information is up to date, accurate and complete. Additionally it is helpful to have the identification information in a form that can be transmitted electronically for example over the internet to speed the process.

Prior art ID programs create a database on a hard drive of a computer during the process of producing the ID card. Although, it is possible to delete and ultimately erase the information from the hard drive when the ID is completed by overwriting it with a program designed for that purpose, it is not clear if prior art techniques erase the information by using a program to overwrite it each time a particular database is deleted, or whether all of the information is actually erased. Deleting a file or folder does not erase the data. Information that has been deleted but has not been overwritten is not erased, and commercial retrieval programs can discover and retrieve the information, allowing it to fall into the hands of criminals.

This security breach is of course unacceptable. An example of how dangerous a child's photos and identifying information would be in the hands of a criminal is that a child predator would have everything they need to wait for, recognize and then pretend that they know a child by calling out his or her name, and convincing them to get into a vehicle or otherwise go along. Multiply this by the thousands of databases that are being created every day by prior art ID programs, with many that include the name and location of the child's school on the ID card, and it is easy to understand how dangerous a database in the hands of an opportunistic criminal, willing to sell the information to other child predators, can be.

### SUMMARY

Personal information of the child, a person or pet is obtained from a parent or guardian and scanned into the program while photo information is obtained by taking two pictures of the child. The invention uses Intelligent Character Recognition (ICR) to scan in the personal information supplied by the parents on a form supplied by a user. The photos are taken during the scanning process, and the photo information is then merged with the personal information and placed on the CD-ROM for safe storage by the parent or legal guardian. There is no other record created, retained or stored by the user.

The present invention uses the computer's random access memory RAM to momentary hold the merged personal and photo information. This information is overwritten by the successive child's information. Furthermore, the RAM is volatile memory, and consequently, when the computer is turned off or has a loss of power, is restarted or re-booted, all information in RAM is lost forever, preventing criminals of accessing the information.

The CD-ROM is easy to carry by the parent or guardian. The CD-ROM includes a software program that uses Simple Mail Transfer Protocol (SMTP) to send e-mail without the need for a Mail Application Program Interface (MAPI) e-mail program on the user's computer. This assures that the missing child's information will be broadcast. There is an edit program that allows additional information to be added by the parent or guardian prior to sending the e-mail.

### BRIEF DESCRIPTION OF THE DRAWINGS

FIG. 1 is a block diagram for the data collection apparatus

FIG. 2 is a diagram of the form for parents to fill out;

FIG. 3 is a diagram of a data area formed on RAM of the computer;

FIG. 4 is a flow diagram of the present invention;

FIG. 5 is another flow diagram of the present invention;

FIG. 6 is a further flow diagram of the present invention;

FIG. 7 is a diagram of the emergency program of the present invention.

### DESCRIPTION

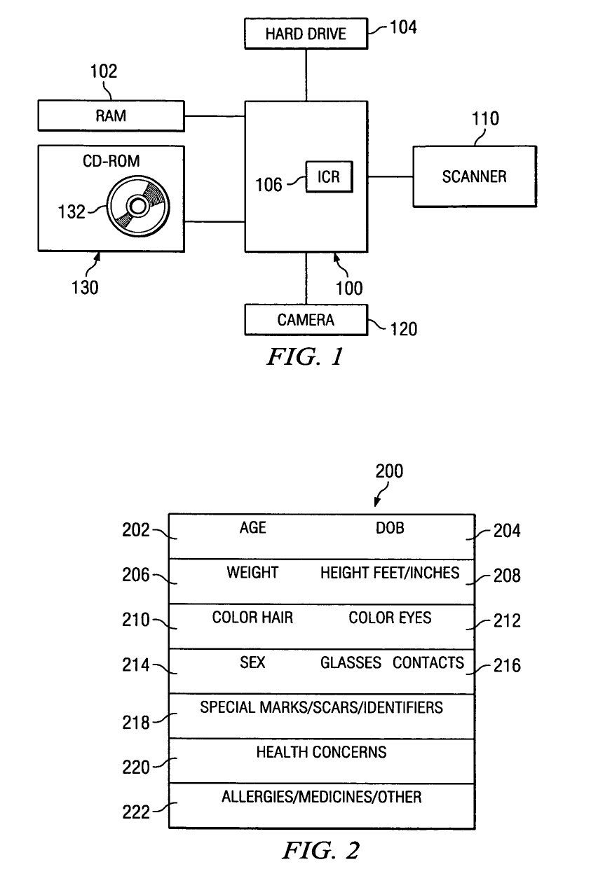

FIG. 1 is a block diagram of the data collection apparatus of the present invention. FIG. 1 shows that the data collection apparatus or system includes a computer 100 including a hard drive 104 and RAM 102, a scanner 110 to scan in personal information about the subject or child, and a camera 120 for recording a photo of the subject. The present invention is described in terms of a child; the present invention could be used with any person or pet. The computer 100 includes ICR software to recognize hand written characters and to convert these handwritten characters to digital information.

FIG. 2 illustrates a form 200 that a parent or guardian would fill out. The form 200 may include the following personal information: Age 202, Date of Birth 204, Weight 206, Height 208, Hair color 210, Eye color 212, Sex 214, Glasses/contacts 216, Special marks 218, Health concerns 220 and Allergies 222. Other types of personal information could be collected.

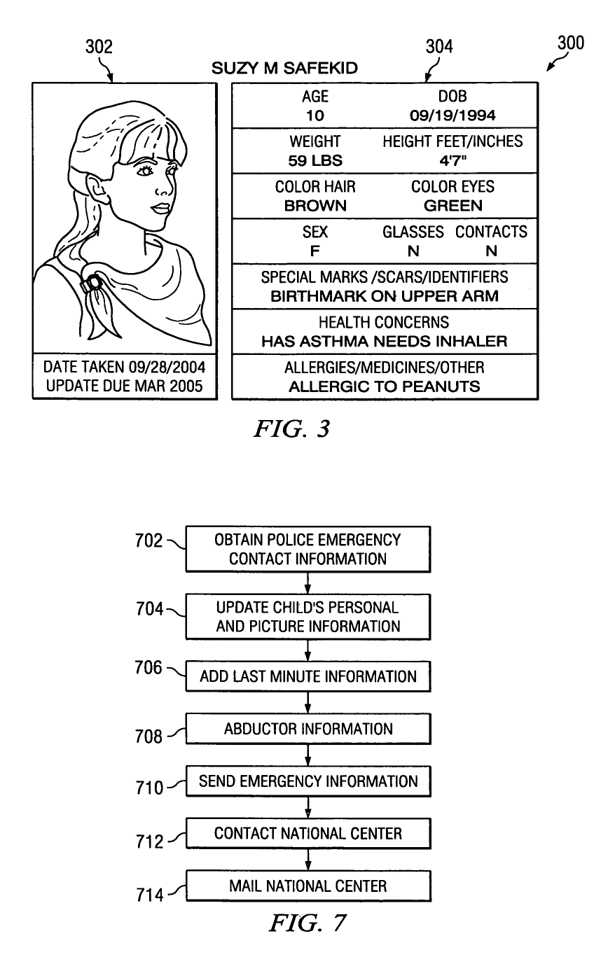

The form 200 is placed into the scanner 110, and the scanner 110 scans the form 200 and transmits the hand written personal information to the computer 100, more specify to the RAM 102 avoiding the hard drive 104 of the computer. The ICR 100 transforms the hand written personal information to digital personal information. At the same time, the camera 120 which may be a digital camera obtains a picture image of the child and transfers the picture image to the RAM 102 of the computer 100, again avoiding the hard drive 104 of the computer 100. The picture data is merged simultaneously with the personal information to form a data area 300 as shown on FIG. 3 in RAM 102 of the computer 100.

FIG. 3 illustrates data area 300 formed in RAM 102 of computer 100. The data area 300 includes picture image 302 and personal information 304.

After both the picture image 302 and the personal information 304 are formed in data area 300, the CD burner is activated. The data area 300 is transferred to the CD burner 130 to place the data are on the CD-ROM 132.

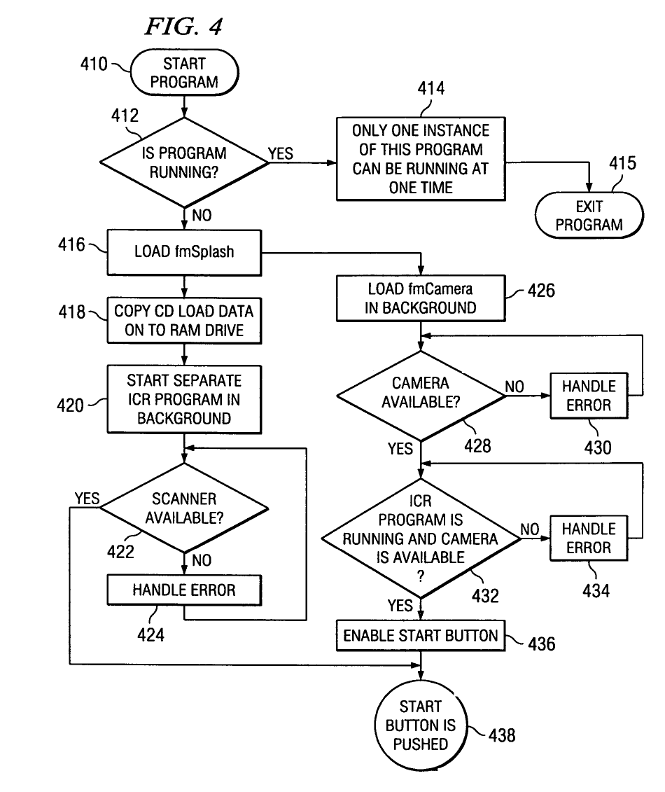

FIG. 4 shows the start of the program at step 410. At step 412, it is determined if the program is already running. If yes, then step 414 is executed recognizing that only one program should run. Control passes to step 415 which exits the program. If the no other program is running, then control pass to step 416 which loads the fmSplash program which is a program to display the main screen and user functions. Control passes to step 418 which copies CD load (a format data for the personal and image information) on the RAM 102. As in step 420, the ICR program is started in background mode to convert the character data to digital data. Control next passes to step 422 which determines if the scanner is available. If the scanner is not available then control passes to step 424 to handle the error and control passes to step 422.

Step 416 additionally passes control to step 426 to load fmCamera program which is a program to control the camera and is run in background mode. fmSplash is still running with fmCamera in background. In step 428, the computer determines if the camera is available. If the camera is not available, then in step 430 an error is recognized. Control is passed to step 428. If the camera is available, then control passes to step 432. In step 432, it is determined if the camera is running and the ICR program is running. If not, then step 434 is for an error. Control then passes to step 432. If both the camera is available and ICR is running, then control is transferred to step 436 which enables the ‘start’ button. Control passes to step 438 when the ‘start’ button is pushed.

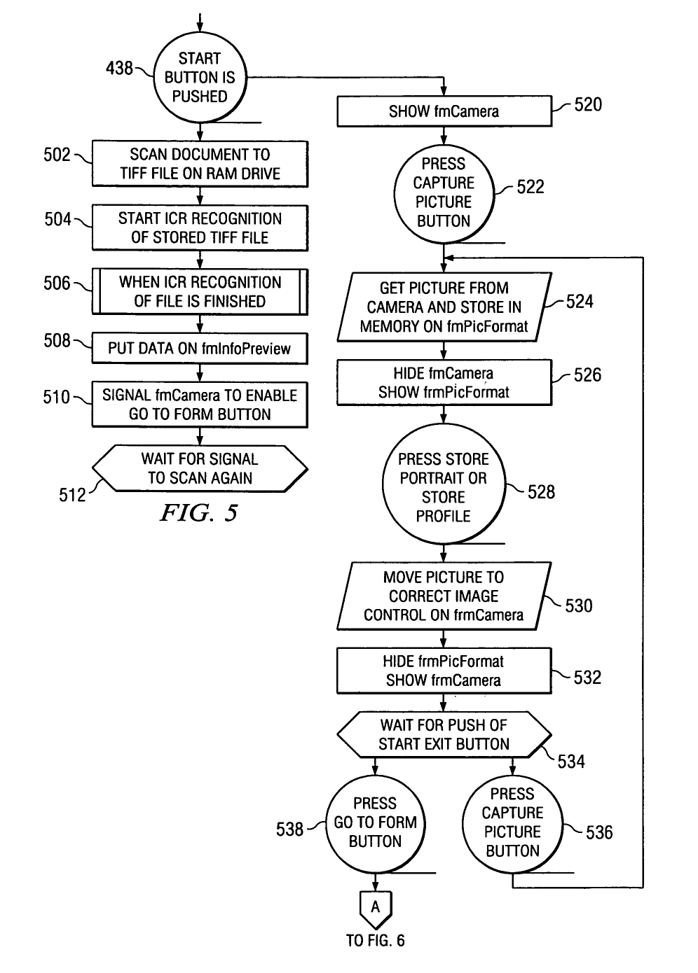

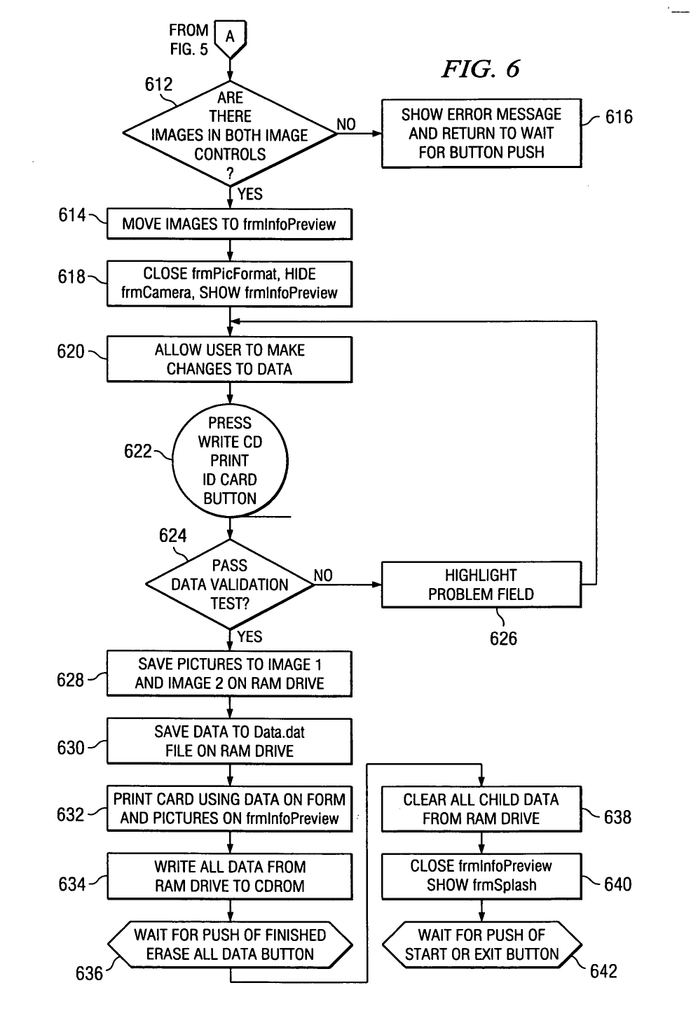

Turning to FIG. 5, FIG. 5 shows step 438 from FIG. 4. Once step 438 is executed; the start button is pushed, two different paths of steps are executed.

In the first path, control is passed to step 502 which scans the personal data on scanner 110 to a TIFF file on RAM 102. Control is passed to step 504 which starts the ICR program to convert the hand written characters to digital information. Control is passed to step 506 when the conversion of the hand written characters is complete. Next, control is passed the step 508 which places the digital personal information on fminfopreview which is a program to preview the digital personal information. Next, control passes to step 510 which provides a signal to the fmCamera program which is a program to display the photos and enable the ‘Go to Form’ button on the screen of the computer. Control passes to step 512 to wait for the signal to scan the next set of personal information.

In the second path, control is passed to step 520 which shows fmCamera program. Control passes to step 522 which activates the ‘Capture Picture’ Button. Control passes to step 524 to obtain the picture information from the camera and stores the picture in memory on ImPicFormat which allows the user to make size and position changes to the picture data, for example define and select a specific area of the displayed picture for final use. Control passes to step 526 which hides ImCamera and shows ImpictFormat. Control passes to step 528 which activates the ‘Store Portrait’ or ‘Store Profile’ button. In step 530, the picture is moved to correct image control on fmCamera program.

Control is passed to step 532 which hides the fmPicFormat program and shows the fmCamera program. Control passes to step 534 which waits for the ‘start’ or ‘exit’ button to be pushed.

In step 536, if the ‘capture picture’ button is pushed, the control is passed to step 524. In step 538, if the ‘Go to Form’ button is pushed then control is passed to step 612

FIG. 6 shows an additional flow chart of the present invention. In step 612, the data location ‘Both image controls’ is checked to see if two images are present. If no, then control is passed to step 616 which shows an error and returns to wait for button push (start button on camera). If yes, the control passes to step 614 which moves the images to data area fmInfoPreview. Control passes to step 618, where fmPicFormat program is closed, fmCamera program is hidden and fmInfoPreview program which is the picture and form preview is shown. Control is passed to step 620 which allows the user to make changes to the data collected from the ICR program, for example correct characters that weren't recognized by the ICR program and to add any missing data. Next, in step 624, the personal data is tested to see if it is complete and valid for example the age is tested to see if it is entered and less that 100, and the personal data is tested for spelling errors, and unrecognized characters. If the personal data does not pass, then control passes to step 626 which highlights the invalid or problem data. Control then returns to step 620. If the personal data passes the validation test in step 624, then control passes to step 628 which saves the picture images as corrected on RAM 102. Control next passes to step 630, which places the personal data on RAM 102. Now, both the personal data and the image data are located on RAM 102. Next control passes to step 632 which transfers the personal data and images to CD-ROM 130. Control passes to step 636 which waits for activation of ‘Finished Erase All Data Button’. When this button is activated, control passes to step 638, which clears all the personal data and image data for the RAM 102. Next, control passes to step 640 which closes the fmintopreview and shows fmSpash and then control passes to step 642 which waits for Start or Exit button to be pushed to start with a new child or exit the program.

Next the data distribution aspect of the present invention is described. The method and apparatus for creating the CD-ROM is described. While the present invention is described in terms of a CD-ROM as the media; the present invention could be used with any computer writable media for example Universal Serial Bus media (USB) or floppy media. The CD-ROM is a business size card size CD that is designed to easily fit into a wallet, purse, or pocket. This CD-ROM is usable and has the ability to broadcast electronically directly from the CD-ROM via internet e-mail by a Simple Mail Transfer Protocol (SMTP) without installation on the user's computer or other outside software for example a MAPI (Mail Applications Program Interface) email program. The software on the CD-ROM allows the parent or guardian to update the picture data and personal information with last minute information for example where the missing or abducted child was last seen, what they were wearing and other information pertinent to the missing child emergency, and change and update other information about the child, for example the most current age information. The CD-ROM includes software to create posters based on the personal information and picture data so that the user can print and distribute these posters in the neighborhood, or send pre-formatted posters via internet e-mail. The updated information can be saved to either a floppy drive or to the computers hard drive, to be used in combination with the software on the CD-ROM. Now that the child is missing, there is no need for secrecy. The usefulness and functionally of the software is retained on the CD-ROM and the updated or changed information is retained by the user's computer hard drive or floppy drive, allowing the software program retained on the CD-ROM to function directly with the users computer.

As can be seen, the present invention provides a valuable repository of information that can quickly and accuracy used, saving valuable time in the search for a missing child.

Computer Data Table

| | | |
|---|---|---|
| Date Created/Modified | Size | File |

Root Directory of supplied compact disc:

| | | |
|---|---|---|
| 08/22/2004 01:50 PM | <DIR> | Package |
| 08/11/2004 04:55 PM | <DIR> | Templates |
| 09/06/2004 10:02 PM | <DIR> | dictfiles |
| 04/05/2003 02:44 PM | <DIR> | Data |
| 03/07/2004 06:28 AM | <DIR> | CDLoad |
| 03/29/2003 11:13 AM | 5,934 | cdError.bas |
| 03/29/2003 11:13 AM | 8,193 | cdEvent.bas |
| 10/30/2003 09:50 AM | 372,736 | CDFILSYS.dll |
| 03/09/2004 05:19 PM | 188,416 | cdDvlp.dll |
| 03/04/2004 03:41 PM | 221,184 | cdParse.dll |
| 06/08/2004 10:35 AM | 491,520 | CDPROC.exe |
| 06/08/2004 10:35 AM | 376,832 | CDPROCMN.exe |
| 10/30/2003 09:50 AM | 348,160 | CDPTPCLS.dll |
| 06/04/2004 02:04 PM | 409,600 | CDPTPCLT.dll |
| 10/30/2003 09:50 AM | 684,032 | CDRAPCLS.dll |
| 10/30/2003 09:50 AM | 323,584 | CDSDK.dll |
| 03/29/2003 11:13 AM | 106,101 | cdType.bas |
| 05/21/2002 04:46 PM | 122,880 | CmSelDlg.dll |
| 07/05/2000 02:23 PM | 167,936 | czs_ui.dll |
| 11/20/2003 05:01 PM | 356,352 | cdDcd.dll |
| 11/15/2001 10:17 AM | 237,568 | deImg010.dll |
| 11/15/2001 08:33 AM | 172,032 | deImg110.dll |
| 08/27/2003 10:21 AM | 188,416 | deImg121.dll |
| 08/18/2003 04:27 PM | 204,800 | deImg131.dll |
| 02/04/2003 12:08 PM | 114,688 | deImg153.dll |
| 02/03/2003 08:29 PM | 147,456 | deImg167.dll |
| 09/11/2003 08:00 AM | 163,840 | deImg168.dll |
| 09/11/2003 08:07 AM | 163,840 | deImg170.dll |
| 11/16/2001 06:06 PM | 380,928 | deImg404.dll |
| 03/01/2002 04:06 PM | 196,608 | DeImgd60.dll |
| 03/29/2003 11:13 AM | 25,252 | cdApi.bas |
| 08/27/2004 04:05 PM | 9,560,064 | DIGIKIDS.exe |
| 05/01/2004 06:35 AM | 9,539,584 | DIGIKIDS.old |
| 08/22/2004 01:50 PM | 5,078 | DIGIKIDS.PDM |
| 10/27/2004 05:24 PM | 2,014 | DIGIKIDS.vbp |
| 07/26/2002 02:02 PM | 44,069 | CAMSETUI.chm |
| 10/27/2004 05:23 PM | 9,564,160 | DIGIKIDS1.exe |
| 10/27/2004 05:29 PM | 1,304,948 | DIGIKIDS1.zip |
| 08/16/2004 09:41 AM | 6,439 | errormsg.bas |
| 12/13/2002 01:25 PM | 61,440 | EWatch.exe |
| 05/11/2003 03:47 AM | 239,189 | F |
| 10/27/2004 03:52 AM | 32,266 | frmCamera.frm |
| 10/27/2004 03:52 AM | 2,395,244 | frmCamera.frx |
| 08/16/2004 09:35 AM | 5,755 | frmCamSelect.frm |
| 08/16/2004 09:35 AM | 4 | frmCamSelect.frx |
| 08/16/2004 09:41 AM | 12,631 | frmCDWriter.frm |
| 08/16/2004 09:41 AM | 1,090 | frmCDWriter.frx |
| 04/16/2003 02:43 AM | 5,363 | frmICR.frm |
| 10/27/2004 05:24 PM | 58,741 | frmInfoPreview.frm |
| 10/27/2004 05:24 PM | 2,362,830 | frmInfoPreview.frx |
| 05/24/2003 10:21 AM | 3,836 | frmInfoPreview.log |
| 10/27/2004 03:52 AM | 9,943 | frmPicFormat.frm |
| 10/27/2004 03:52 AM | 2,359,364 | frmPicFormat.frx |
| 08/16/2004 09:41 AM | 19,890 | frmPrintCard.frm |
| 08/16/2004 09:41 AM | 1,090 | frmPrintCard.frx |
| 08/27/2004 04:04 PM | 10,179 | frmSplash.frm |
| 05/17/2003 04:49 AM | 11,225 | frmSplash.frm-1 |
| 08/27/2004 04:04 PM | 2,203,470 | frmSplash.frx |
| 06/13/2003 05:40 PM | 167,936 | IWrap.dll |
| 03/05/2004 02:40 PM | 2,094 | modCapsLock.bas |
| 04/10/2003 10:55 PM | 8,589 | modCDWriteError.bas |
| 08/22/2004 09:24 AM | 2,973 | modGen.bas |
| 08/16/2004 09:41 AM | 5,832 | modUsageCounter.bas |
| 08/11/2004 11:07 AM | 29,798 | mpi_api.bas |
| 01/08/2004 05:41 PM | 138,752 | acwmpi32.dll |
| 04/01/2003 09:19 PM | 6,552 | picRotate.bas |
| 06/04/2004 04:38 AM | 28,672 | Progress.exe |
| 08/21/2003 05:18 PM | 598,016 | psCamDat.dll |
| 04/02/2003 12:04 PM | 356,352 | pscDcd.dll |
| 05/29/2001 01:10 PM | 180,224 | pscDevUI.dll |
| 06/25/2003 09:23 AM | 139,264 | pscDvlp.dll |
| 07/02/2003 07:38 AM | 217,088 | pscParse.dll |
| 04/01/2003 08:56 PM | 7,620 | RelCtrl.bas |
| 10/27/2004 05:24 PM | 795 | DIGIKIDS.vbw |
| 70 File(s) | 8,090,055 bytes | |

Directory of C:\Share\DIGIKIDS Project\DIGIKIDS\CDLoad

| | | |
|---|---|---|
| 03/07/2004 06:28 AM | <DIR> | .. |
| 04/27/2004 05:27 AM | <DIR> | CD |
| 03/07/2004 06:28 AM | <DIR> | . |
| 05/12/2003 03:24 PM | | 131 seed.txt |
| 1 File(s) | 131 bytes | |

Directory of C:\Share\DIGIKIDS Project\DIGIKIDS\CDLoad\CD

| | | |
|---|---|---|
| 04/27/2004 05:27 AM | <DIR> | . |
| 04/27/2004 05:27 AM | <DIR> | .. |
| 03/06/2004 04:21 AM | <DIR> | images |
| 04/27/2004 05:27 AM | <DIR> | Setup |
| 03/06/2004 04:21 AM | <DIR> | Documents |
| 08/28/2004 04:01 AM | 11,394 | CDViewer.hta |
| 04/22/2004 07:55 AM | 34,536 | cd_instructions.htm |
| 04/23/2004 03:46 AM | 94,922 | childedit.hta |
| 04/11/2004 12:10 PM | 12,942 | DIGIKIDS_License_Agreement.htm |
| 05/02/2002 05:23 PM | 39 | Autorun.inf |
| 04/21/2004 04:11 AM | 4,953 | autorun.hta |
| 03/07/2004 06:54 AM | 3,891 | emergEmail.htm |
| 03/07/2004 06:53 AM | 6,879 | EmergNCMEC.htm |
| 04/02/2004 09:27 AM | 5,323 | emergStart.htm |
| 03/04/2004 05:00 PM | 181,942 | emerg_tom.hta |
| 04/21/2004 04:07 AM | 1,951 | help.hta |
| 04/21/2004 04:07 AM | 9,062 | home.hta |
| 08/22/2002 09:10 AM | 36,864 | Autorun.exe |
| 04/01/2004 06:26 AM | 1,991 | ncmec.htm |
| 04/21/2004 04:08 AM | 4,911 | SaveOptions.hta |
| 04/27/2004 05:16 AM | 189,824 | emerg.hta |
| 04/01/2004 06:25 AM | 43,719 | viewinfo.htm |
| 04/01/2004 06:25 AM | 6,186 | viewprint.hta |
| 18 File(s) | 651,329 bytes | |

Directory of
C:\Share\DIGIKIDSProject\DIGIKIDS\CDLoad\CD\Documents

| | | |
|---|---|---|
| 03/06/2004 04:21 AM | <DIR> | .. |
| 03/06/2004 04:21 AM | <DIR> | English |
| 11/05/2004 04:12 PM | <DIR> | Espa$$ol |
| 03/06/2004 04:21 AM | <DIR> | . |
| 0 File(s) | 0 bytes | |

Directory of
C:\Share\DIGIKIDSProject\DIGIKIDS\CDLoad\CD\Documents\English

| | | |
|---|---|---|
| 03/06/2004 04:21 AM | <DIR> | .. |
| 03/06/2004 04:21 AM | <DIR> | . |
| 11/06/2003 01:00 PM | 43,724 | Be Prepared Instructions.pdf |
| 03/06/2004 12:44 AM | 0 | English PDF Files go Here.txt |
| 11/05/2003 01:47 PM | 64,825 | School Safety Tips.pdf |
| 11/08/2003 11:01 AM | 2,698,107 | When Your Child is Missing - A |
| | | Family Survival Guide.pdf |
| 11/05/2003 01:51 PM | 48,683 | 8 Rules For Safety.pdf |
| 5 File(s) | 2,855,339 bytes | |

Directory of
C:\Share\DIGIKIDSProject\DIGIKIDS\CDLoad\CD\Documents\Espanol

| | | |
|---|---|---|
| 11/05/2004 04:12 PM | <DIR> | .. |
| 11/05/2004 04:12 PM | <DIR> | . |
| 11/08/2003 10:55 AM | 24,441 | Cu ndo Su Ni$$o Pierde.pdf |
| 03/06/2004 12:44 AM | 0 | Espanol PDF Files go Here.txt |
| 11/08/2003 10:59 AM | 38,010 | Estas son mis 8 Reglas de |
| | | Seguridad.pdf |
| 11/08/2003 10:56 AM | 19,046 | Consejos De Seguridad Para La |
| | | Escuela.pdf |
| 4 File(s) | 81,497 bytes | |

Directory of C:\Share\DIGIKIDS Project\DIGIKIDS\CDLoad\CD\images

| | | |
|---|---|---|
| 03/06/2004 04:21 AM | <DIR> | .. |
| 04/27/2004 05:26 AM | <DIR> | Buttons |
| 03/06/2004 04:21 AM | <DIR> | . |
| 02/19/2004 02:29 PM | 11,926 | clockW.gif |
| 02/26/2004 04:35 PM | 2,433 | code_adam.gif |
| 09/20/2003 07:39 PM | 5,178 | logo_old.gif |
| 12/17/2003 08:28 AM | 5,178 | logo_s.gif |
| 05/14/2003 12:20 PM | 2,106 | ncmec.gif |
| 03/06/2004 04:18 AM | 25,600 | Thumbs.db |
| 6 File(s) | 52,421 bytes | |

Directory of
C:\Share\DIGIKIDSProject\DIGIKIDS\CDLoad\CD\images\Buttons

| | | |
|---|---|---|
| 04/27/2004 05:26 AM | <DIR> | .. |
| 04/27/2004 05:26 AM | <DIR> | . |
| 02/26/2004 03:11 PM | 4,044 8 | Rules-over.gif |
| 02/26/2004 03:10 PM | 4,044 8 | Rules.gif |
| 02/23/2004 10:32 PM | 2,506 | abductor-down.gif |
| 02/23/2004 10:33 PM | 2,546 | abductor-over.gif |
| 02/23/2004 10:32 PM | 2,562 | abductor.gif |
| 02/26/2004 03:11 PM | 6,045 | Adobe-over.gif |
| 02/26/2004 03:10 PM | 6,046 | Adobe.gif |
| 12/18/2003 09:44 AM | 791 | Cancel-down.gif |
| 12/18/2003 09:44 AM | 814 | Cancel-over.gif |
| 12/18/2003 09:44 AM | 814 | Cancel.gif |
| 12/17/2003 03:56 PM | 1,762 | Child-down.gif |
| 12/17/2003 03:56 PM | 1,786 | Child-over.gif |
| 12/17/2003 03:56 PM | 1,709 | Child.gif |
| 02/23/2004 10:33 PM | 2,501 | ChildBio-down.gif |
| 02/23/2004 10:33 PM | 2,543 | ChildBio-over.gif |
| 02/23/2004 10:33 PM | 2,550 | ChildBio.gif |
| 12/17/2003 10:02 AM | 2,285 | Edit-down.gif |
| 12/17/2003 10:03 AM | 2,356 | Edit-over.gif |
| 12/17/2003 10:04 AM | 2,366 | Edit.gif |
| 12/17/2003 10:22 AM | 2,060 | Emerg-down.gif |
| 12/17/2003 10:22 AM | 2,168 | Emerg-over.gif |
| 12/17/2003 10:22 AM | 2,137 | Emerg.gif |
| 12/17/2003 10:02 AM | 1,745 | Exit-down.gif |
| 12/17/2003 10:04 AM | 1,810 | Exit-over.gif |
| 12/17/2003 10:04 AM | 1,795 | Exit.gif |
| 11/11/2003 09:09 AM | 1,488 | floppy.gif |
| 11/11/2003 09:17 AM | 1,350 | floppy1.gif |
| 11/11/2003 09:12 AM | 1,220 | floppy2.gif |
| 12/18/2003 01:14 PM | 1,777 | Flyer-down.gif |
| 12/18/2003 01:14 PM | 1,855 | Flyer-over.gif |
| 12/18/2003 01:13 PM | 1,848 | Flyer.gif |
| 10/19/2003 11:09 AM | 1,677 | Help_But-down.gif |
| 10/19/2003 11:09 AM | 1,702 | Help_But-over.gif |
| 10/19/2003 11:08 AM | 1,785 | Help_But.gif |
| 12/17/2003 06:07 PM | 951 | Help_lu.GIF |
| 10/07/2003 04:25 PM | 1,043 | Help_lu_over.GIF |
| 12/17/2003 10:03 AM | 1,794 | Home-down.gif |
| 12/17/2003 10:04 AM | 1,866 | Home-over.gif |
| 12/17/2003 10:05 AM | 1,869 | Home.gif |
| 09/22/2003 07:17 PM | 2,193 | inet_world_fade.gif |
| 09/22/2003 07:08 PM | 2,088 | inet_world_shadow.gif |
| 09/22/2003 07:37 PM | 2,082 | inet_world_shadow2.gif |
| 12/17/2003 10:03 AM | 2,105 | Instr-down.gif |
| 12/17/2003 10:05 AM | 2,161 | Instr-over.gif |
| 12/17/2003 10:05 AM | 2,141 | Instr.gif |
| 12/17/2003 05:59 PM | 1,788 | Med-down.gif |
| 12/17/2003 05:59 PM | 1,816 | Med-over.gif |
| 12/17/2003 05:59 PM | 1,737 | Med.gif |
| 02/26/2004 03:11 PM | 5,977 | Missing-over.gif |
| 02/26/2004 03:11 PM | 5,983 | Missing.gif |
| 02/26/2004 05:04 PM | 1,352 | moreInstr-over.gif |
| 02/26/2004 05:04 PM | 950 | moreInstr.gif |
| 10/19/2003 11:25 AM | 1,756 | Next-down.gif |
| 10/19/2003 11:26 AM | 1,794 | Next-over.gif |
| 10/19/2003 11:25 AM | 1,794 | Next.gif |
| 12/17/2003 03:51 PM | 1,896 | P1-down.gif |
| 12/17/2003 03:51 PM | 1,926 | P1-over.gif |
| 12/17/2003 03:51 PM | 1,835 | P1.gif |
| 12/17/2003 03:51 PM | 1,925 | P2-down.gif |
| 12/17/2003 03:51 PM | 1,953 | P2-over.gif |
| 12/17/2003 03:51 PM | 1,891 | P2.gif |
| 12/17/2003 12:46 PM | 1,837 | Poster-down.gif |
| 12/17/2003 12:47 PM | 1,900 | Poster-over.gif |
| 12/17/2003 12:47 PM | 1,885 | Poster.gif |
| 02/26/2004 03:11 PM | 5,219 | Prepared-over.gif |
| 02/26/2004 03:10 PM | 1,745 | Prev-down.gif |
| 10/19/2003 11:26 AM | 1,783 | Prev-over.gif |
| 10/19/2003 11:26 AM | 1,762 | Prev.gif |
| 02/23/2004 10:31 PM | 2,072 | Print-down.gif |
| 02/23/2004 10:31 PM | 2,116 | Print-over.gif |
| 02/23/2004 10:30 PM | 2,113 | Print.gif |
| 02/23/2004 10:31 PM | 2,473 | release-down.gif |
| 02/23/2004 10:32 PM | 2,513 | release-over.gif |
| 02/23/2004 10:31 PM | 2,496 | release.gif |
| 04/04/2004 11:47 AM | 2,178 | RemData-down.gif |
| 04/04/2004 11:47 AM | 2,200 | RemData-over.gif |
| 04/04/2004 11:46 AM | 2,192 | RemData.gif |
| 03/05/2004 09:16 PM | 2,336 | Safety-down.gif |
| 03/05/2004 09:16 PM | 2,342 | Safety-over.gif |
| 03/05/2004 09:16 PM | 2,333 | Safety.gif |
| 12/17/2003 12:47 PM | 1,783 | Save-down.gif |
| 12/17/2003 12:48 PM | 1,847 | Save-over.gif |
| 12/17/2003 12:48 PM | 1,841 | Save.gif |
| 12/17/2003 02:49 PM | 2,442 | SaveFD-down.gif |
| 12/17/2003 02:49 PM | 3,042 | SaveFD-over.gif |
| 12/17/2003 02:49 PM | 2,418 | SaveFD.gif |
| 12/17/2003 02:49 PM | 2,395 | SaveHD-down.gif |
| 12/17/2003 02:49 PM | 2,401 | SaveHD-over.gif |
| 12/17/2003 02:49 PM | 2,318 | SaveHD.gif |
| 02/26/2004 03:11 PM | 4,163 | School-over.gif |
| 02/26/2004 03:10 PM | 4,164 | School.gif |
| 10/07/2003 05:01 PM | 1,297 | Start-down.gif |
| 10/07/2003 05:01 PM | 1,319 | Start-over.gif |
| 10/07/2003 05:01 PM | 1,298 | Start.gif |
| 12/17/2003 05:12 PM | 1,336 | Step1-down.gif |
| 12/17/2003 05:12 PM | 1,343 | Step1-over.gif |
| 12/17/2003 05:12 PM | 1,331 | Step1.gif |
| 12/17/2003 05:12 PM | 1,344 | Step2-down.gif |
| 12/17/2003 05:12 PM | 1,349 | Step2-over.gif |
| 12/17/2003 05:12 PM | 1,342 | Step2.gif |
| 12/17/2003 05:12 PM | 1,340 | Step3-down.gif |
| 12/17/2003 05:12 PM | 1,349 | Step3-over.gif |
| 12/17/2003 05:12 PM | 1,332 | Step3.gif |
| 12/17/2003 05:12 PM | 1,335 | Step4-down.gif |
| 12/17/2003 05:12 PM | 1,340 | Step4-over.gif |
| 12/17/2003 05:12 PM | 1,341 | Step4.gif |
| 12/19/2003 10:21 AM | 1,347 | Step5-down.gif |
| 12/19/2003 10:21 AM | 1,348 | Step5-over.gif |
| 12/19/2003 10:21 AM | 1,338 | Step5.gif |
| 12/19/2003 10:21 AM | 1,356 | Step6-down.gif |
| 12/19/2003 10:21 AM | 1,359 | Step6-over.gif |
| 12/19/2003 10:21 AM | 1,347 | Step6.gif |
| 12/19/2003 10:21 AM | 1,343 | Step7-down.gif |
| 12/19/2003 10:21 AM | 1,336 | Step7-over.gif |
| 12/19/2003 10:21 AM | 1,334 | Step7.gif |
| 03/06/2004 11:34 AM | 365,056 | Thumbs.db |
| 02/23/2004 05:07 PM | 2,368 | viewPrint-down.gif |
| 02/23/2004 05:07 PM | 2,378 | viewPrint-over.gif |
| 02/23/2004 05:07 PM | 2,331 | viewPrint.gif |
| 120 File(s) | 614,923 bytes | |

Directory of C:\Share\DIGIKIDS Project\DIGIKIDS\CDLoad\CD\Setup

| | | |
|---|---|---|
| 04/27/2004 05:27 AM | <DIR> | .. |
| 04/27/2004 05:27 AM | <DIR> | . |
| 09/24/2003 10:24 AM | 143,360 | AspEmail.dll |
| 03/07/2004 09:28 AM | 283 | Data.dat |
| 03/07/2004 09:28 AM | 283 | data.txt |
| 03/06/2004 12:01 AM | 9,040 | Distribution_Flyer.htm |
| 04/30/2004 02:22 PM | 12,843 | EmergFL.hta |
| 03/07/2004 09:28 AM | 23,153 | image1.jpg |
| 03/07/2004 09:28 AM | 23,035 | image2.jpg |
| 04/01/2004 06:35 AM | 7,607 | InstallFL.hta |
| 04/01/2004 06:36 AM | 9,536 | NCMEC_abductor_bio.rtf |
| 02/23/2004 03:20 PM | 10,515 | NCMEC_child_bio.rtf |
| 02/19/2004 05:38 PM | 8,968 | NCMEC_release.rtf |
| 12 File(s) | 255,693 bytes | |

Directory of C:\Share\DIGIKIDS Project\DIGIKIDS\Data

| | | |
|---|---|---|
| 04/05/2003 02:44 PM | <DIR> | .. |
| 04/05/2003 02:44 PM | <DIR> | Alternate |
| 04/05/2003 02:44 PM | <DIR> | . |
| 09/11/1999 12:34 AM | 1,951,254 | Gs130mac.pat |
| 03/11/1997 06:05 AM | 23,481 | Gs130mcr.ewf |
| 10/06/1999 09:37 PM | 5,435,267 | Gs130ush.pat |
| 10/26/1999 01:21 AM | 33,852 | Chardim.txt |
| 4 File(s) | 7,443,854 bytes | |

Directory of C:\Share\DIGIKIDS Project\DIGIKIDS\Data\Alternate

| | | |
|---|---|---|
| 04/05/2003 02:44 PM | <DIR> | .. |
| 04/05/2003 02:44 PM | <DIR> | . |
| 01/27/1998 10:29 AM | 291,014 | Gs130mac.dis |
| 04/07/1999 12:51 PM | 1,761,397 | Gs130mac.ewf |
| 03/10/1997 06:05 PM | 23,481 | Gs130mcr.ewf |
| 03/31/1999 02:25 PM | 3,046,205 | Gs130ush.ewf |
| 07/23/2001 12:52 PM | 30,607 | Chardim.txt |
| 5 File(s) | 5,152,704 bytes | |

Directory of C:\Share\DIGIKIDS Project\DIGIKIDS\dictfiles

| | | |
|---|---|---|
| 09/06/2004 10:02 PM | <DIR> | .. |
| 09/06/2004 10:02 PM | <DIR> | . |
| 04/16/2003 04:38 AM | 18,892 | FirstNames.dct |
| 04/16/2003 05:09 AM | 140,819 | LastNames.dct |
| 04/20/2003 07:57 AM | 132 | USER1.DCT |
| 01/10/2001 02:20 PM | 1,344,491 | default.DCT |
| 4 File(s) | 1,504,334 bytes | |

Directory of C:\Share\DIGIKIDS Project\DIGIKIDS\Package

| | | |
|---|---|---|
| 08/22/2004 01:50 PM | <DIR> | .. |
| 08/22/2004 01:50 PM | <DIR> | Support |
| 08/22/2004 01:50 PM | <DIR> | . |
| 08/22/2004 01:50 PM | 5,139 | SETUP.LST |
| 06/18/1998 12:00 AM | 140,800 | setup.exe |
| 08/22/2004 01:50 PM | 5,174,991 | DIGIKIDS.CAB |
| 3 File(s) | 5,320,930 bytes | |

Directory of C:\Share\DIGIKIDS Project\DIGIKIDS\Package\Support

| | | |
|---|---|---|
| 08/22/2004 01:50 PM | <DIR> | .. |
| 08/22/2004 01:50 PM | <DIR> | . |
| 08/29/2002 06:00 AM | 77,824 | ASYCFILT.DLL |
| 10/30/2003 09:50 AM | 323,584 | CDSDK.dll |
| 01/15/2003 10:09 AM | 516,096 | CDWriterXP.ocx |
| 05/31/1998 12:00 AM | 22,288 | COMCAT.DLL |
| 08/22/2004 01:50 PM | 191 | DIGIKIDS.BAT |
| 08/22/2004 01:50 PM | 728 | DIGIKIDS.DDF |
| 08/22/2004 11:34 AM | 9,560,064 | DIGIKIDS.exe |
| 08/22/2004 11:33 AM | 45,056 | DIGIKIDS_ICR.exe |
| 01/22/2003 09:56 AM | 581,632 | Imagr6.dll |
| 02/03/2003 03:07 PM | 577,536 | ImagX6.dll |
| 02/05/2003 10:59 AM | 324,808 | ImagXpr6.dll |
| 08/10/2004 09:05 AM | 140,288 | MPIWIN32.DLL |
| 06/26/1998 12:00 AM | 1,062,704 | MSCOMCTL.OCX |
| 08/29/2002 06:00 AM | 1,388,544 | MSVBVM60.DLL |
| 08/29/2002 06:00 AM | 323,072 | MSVCRT.DLL |
| 08/29/2002 06:00 AM | 569,344 | OLEAUT32.DLL |
| 08/29/2002 06:00 AM | 106,496 | OLEPRO32.DLL |
| 01/17/2003 10:27 AM | 43,008 | PICN20.DLL |
| 09/12/2002 01:54 PM | 214,216 | PrntPRO2.dll |
| 06/04/2004 04:33 AM | 174,352 | RICHED32.DLL |
| 05/07/1999 03:00 AM | 204,296 | RICHTX32.OCX |
| 08/29/2002 06:00 AM | 147,483 | SCRRUN.DLL |
| 06/18/1998 12:00 AM | 140,800 | SETUP.EXE |
| 08/22/2004 01:50 PM | 5,139 | Setup.Lst |
| 06/20/1998 12:00 AM | 286,720 | SETUP1.EXE |
| 11/26/2002 11:59 AM | 271,616 | Spell8.ocx |
| 06/18/1998 12:00 AM | 73,216 | ST6UNST.EXE |
| 08/29/2002 06:00 AM | 17,920 | STDOLE2.TLB |
| 06/18/1998 12:00 AM | 102,912 | VB6STKIT.DLL |
| 30 File(s) | 17,330,605 bytes | |

Directory of C:\Share\DIGIKIDS Project\DIGIKIDS\Templates

| | | |
|---|---|---|
| 08/11/2004 04:55 PM | <DIR> | .. |
| 08/11/2004 04:55 PM | <DIR> | . |
| 08/11/2004 05:16 PM | 1,116,390 | image-workingFile.tif |
| 04/20/2003 04:11 AM | 14,848 | Thumbs.db |
| 10/27/2004 04:38 AM | 10,752 | fieldTemplate.nxp |
| 4 File(s) | 1,152,742 bytes | |
| Total Files Listed: | | |
| 286 File(s) | 90,506,557 bytes | |
| 44 Dir(s) | 11,655,557,120 bytes free | |

Directory of C:\Share\DIGIKI˜1\DIGIKIDS\CDLoad

| | | |
|---|---|---|
| 03/07/2004 06:28 AM | <DIR> | .. |
| 04/27/2004 05:27 AM | <DIR> | CD |
| 03/07/2004 06:28 AM | <DIR> | . |
| 05/12/2003 03:24 PM | | 131 seed.txt |
| 1 File(s) | 131 bytes | |

Directory of C:\Share\DIGIKI˜1\DIGIKIDS\CDLoad\CD

| | | |
|---|---|---|
| 04/27/2004 05:27 AM | <DIR> | . |
| 04/27/2004 05:27 AM | <DIR> | .. |
| 03/06/2004 04:21 AM | <DIR> | images |
| 04/27/2004 05:27 AM | <DIR> | Setup |
| 03/06/2004 04:21 AM | <DIR> | Documents |
| 08/28/2004 04:01 AM | 11,394 | CDViewer.hta |
| 04/22/2004 07:55 AM | 34,536 | cd_instructions.htm |
| 04/23/2004 03:46 AM | 94,922 | childedit.hta |
| 04/11/2004 12:10 PM | 12,942 | DIGIKIDS_License_Agreement.htm |
| 05/02/2002 05:23 PM | 39 | Autorun.inf |
| 04/21/2004 04:11 AM | 4,953 | autorun.hta |
| 03/07/2004 06:54 AM | 3,891 | emergEmail.htm |
| 03/07/2004 06:53 AM | 6,879 | EmergNCMEC.htm |
| 04/02/2004 09:27 AM | 5,323 | emergStart.htm |
| 03/04/2004 05:00 PM | 181,942 | emerg_tom.hta |
| 04/21/2004 04:07 AM | 1,951 | help.hta |
| 04/21/2004 04:07 AM | 9,062 | home.hta |
| 08/22/2002 09:10 AM | 36,864 | Autorun.exe |
| 04/01/2004 06:26 AM | 1,991 | ncmec.htm |
| 04/21/2004 04:08 AM | 4,911 | SaveOptions.hta |
| 04/27/2004 05:16 AM | 189,824 | emerg.hta |
| 04/01/2004 06:25 AM | 43,719 | viewinfo.htm |
| 04/01/2004 06:25 AM | 6,186 | viewprint.hta |
| 18 File(s) | 651,329 bytes | |

Directory of C:\Share\DIGIKI˜1\DIGIKIDS\CDLoad\CD\Documents

| | | |
|---|---|---|
| 03/06/2004 04:21 AM | <DIR> | .. |
| 03/06/2004 04:21 AM | <DIR> | English |
| 11/05/2004 04:12 PM | <DIR> | Espanol |
| 03/06/2004 04:21 AM | <DIR> | . |
| 0 File(s) | 0 bytes | |

Directory of
C:\Share\DIGIKI˜1\DIGIKIDS\CDLoad\CD\Documents\English

| | | |
|---|---|---|
| 03/06/2004 04:21 AM | <DIR> | .. |
| 03/06/2004 04:21 AM | <DIR> | . |
| 11/06/2003 01:00 PM | 43,724 | Be Prepared Instructions.pdf |
| 03/06/2004 12:44 AM | 0 | English PDF Files go Here.txt |
| 11/05/2003 01:47 PM | 64,825 | School Safety Tips.pdf |
| 11/08/2003 11:01 AM | 2,698,107 | When Your Child is Missing - A |
| | | Family Survival Guide.pdf |
| 11/05/2003 01:51 PM | 48,683 | 8 Rules For Safety.pdf |
| 5 File(s) | 2,855,339 bytes | |

Directory of
C:\Share\DIGIKI˜1\DIGIKIDS\CDLoad\CD\Documents\Espanol

| | | |
|---|---|---|
| 11/05/2004 04:12 PM | <DIR> | .. |
| 11/05/2004 04:12 PM | <DIR> | . |
| 11/08/2003 10:55 AM | 24,441 | Cu ndo Su Ni$$o Pierde.pdf |
| 03/06/2004 12:44 AM | 0 | Espanol PDF Files go Here.txt |
| 11/08/2003 10:59 AM | 38,010 | Estas son mis 8 Reglas de |
| | | Seguridad.pdf |
| 11/08/2003 10:56 AM | 19,046 | Consejos De Seguridad Para La |
| | | Escuela.pdf |
| 4 File(s) | 81,497 bytes | |

Directory of C:\Share\DIGIKI˜1\DIGIKIDS\CDLoad\CD\images

| | | |
|---|---|---|
| 03/06/2004 04:21 AM | <DIR> | .. |
| 04/27/2004 05:26 AM | <DIR> | Buttons |
| 03/06/2004 04:21 AM | <DIR> | . |
| 02/19/2004 02:29 PM | 11,926 | clockW.gif |
| 02/26/2004 04:35 PM | 2,433 | code_adam.gif |
| 09/20/2003 07:39 PM | 5,178 | logo_old.gif |
| 12/17/2003 08:28 AM | 5,178 | logo_s.gif |
| 05/14/2003 12:20 PM | 2,106 | ncmec.gif |
| 03/06/2004 04:18 AM | 25,600 | Thumbs.db |
| 6 File(s) | 52,421 bytes | |

Directory of C:\Share\DIGIKI˜1\DIGIKIDS\CDLoad\CD\images\Buttons

| | | |
|---|---|---|
| 04/27/2004 05:26 AM | <DIR> | .. |
| 04/27/2004 05:26 AM | <DIR> | . |
| 02/26/2004 03:11 PM | 4,044 | 8Rules-over.gif |
| 02/26/2004 03:10 PM | 4,044 | 8Rules.gif |
| 02/23/2004 10:32 PM | 2,506 | abductor-down.gif |
| 02/23/2004 10:33 PM | 2,546 | abductor-over.gif |
| 02/23/2004 10:32 PM | 2,562 | abductor.gif |
| 02/26/2004 03:11 PM | 6,045 | Adobe-over.gif |
| 02/26/2004 03:10 PM | 6,046 | Adobe.gif |
| 12/18/2003 09:44 AM | 791 | Cancel-down.gif |
| 12/18/2003 09:44 AM | 814 | Cancel-over.gif |
| 12/18/2003 09:44 AM | 814 | Cancel.gif |
| 12/17/2003 03:56 PM | 1,762 | Child-down.gif |
| 12/17/2003 03:56 PM | 1,786 | Child-over.gif |
| 12/17/2003 03:56 PM | 1,709 | Child.gif |
| 02/23/2004 10:33 PM | 2,501 | ChildBio-down.gif |
| 02/23/2004 10:33 PM | 2,543 | ChildBio-over.gif |
| 02/23/2004 10:33 PM | 2,550 | ChildBio.gif |
| 12/17/2003 10:02 AM | 2,285 | Edit-down.gif |
| 12/17/2003 10:03 AM | 2,356 | Edit-over.gif |
| 12/17/2003 10:04 AM | 2,366 | Edit.gif |
| 12/17/2003 10:22 AM | 2,060 | Emerg-down.gif |
| 12/17/2003 10:22 AM | 2,168 | Emerg-over.gif |
| 12/17/2003 10:22 AM | 2,137 | Emerg.gif |
| 12/17/2003 10:02 AM | 1,745 | Exit-down.gif |
| 12/17/2003 10:04 AM | 1,810 | Exit-over.gif |
| 12/17/2003 10:04 AM | 1,795 | Exit.gif |
| 11/11/2003 09:09 AM | 1,488 | floppy.gif |
| 11/11/2003 09:17 AM | 1,350 | floppy1.gif |
| 11/11/2003 09:12 AM | 1,220 | floppy2.gif |
| 12/18/2003 01:14 PM | 1,777 | Flyer-down.gif |
| 12/18/2003 01:14 PM | 1,855 | Flyer-over.gif |
| 12/18/2003 01:13 PM | 1,848 | Flyer.gif |
| 10/19/2003 11:09 AM | 1,677 | Help_But-down.gif |
| 10/19/2003 11:09 AM | 1,702 | Help_But-over.gif |
| 10/19/2003 11:08 AM | 1,785 | Help_But.gif |
| 12/17/2003 06:07 PM | 951 | Help_lu.GIF |
| 10/07/2003 04:25 PM | 1,043 | Help_lu_over.GIF |
| 12/17/2003 10:03 AM | 1,794 | Home-down.gif |
| 12/17/2003 10:04 AM | 1,866 | Home-over.gif |
| 12/17/2003 10:05 AM | 1,869 | Home.gif |
| 09/22/2003 07:17 PM | 2,193 | inet_world_fade.gif |
| 09/22/2003 07:08 PM | 2,088 | inet_world_shadow.gif |
| 09/22/2003 07:37 PM | 2,082 | inet_world_shadow2.gif |
| 12/17/2003 10:03 AM | 2,105 | Instr-down.gif |
| 12/17/2003 10:05 AM | 2,161 | Instr-over.gif |
| 12/17/2003 10:05 AM | 2,141 | Instr.gif |
| 12/17/2003 05:59 PM | 1,788 | Med-down.gif |
| 12/17/2003 05:59 PM | 1,816 | Med-over.gif |
| 12/17/2003 05:59 PM | 1,737 | Med.gif |
| 02/26/2004 03:11 PM | 5,977 | Missing-over.gif |
| 02/26/2004 03:11 PM | 5,983 | Missing.gif |
| 02/26/2004 05:04 PM | 1,352 | moreInstr-over.gif |
| 02/26/2004 05:04 PM | 950 | moreInstr.gif |
| 10/19/2003 11:25 AM | 1,756 | Next-down.gif |
| 10/19/2003 11:26 AM | 1,794 | Next-over.gif |
| 10/19/2003 11:25 AM | 1,794 | Next.gif |
| 12/17/2003 03:51 PM | 1,896 | P1-down.gif |
| 12/17/2003 03:51 PM | 1,926 | P1-over.gif |
| 12/17/2003 03:51 PM | 1,835 | P1.gif |
| 12/17/2003 03:51 PM | 1,925 | P2-down.gif |
| 12/17/2003 03:51 PM | 1,953 | P2-over.gif |
| 12/17/2003 03:51 PM | 1,891 | P2.gif |
| 12/17/2003 12:46 PM | 1,837 | Poster-down.gif |
| 12/17/2003 12:47 PM | 1,900 | Poster-over.gif |
| 12/17/2003 12:47 PM | 1,885 | Poster.gif |
| 02/26/2004 03:11 PM | 5,219 | Prepared-over.gif |
| 02/26/2004 03:10 PM | 5,224 | Prepared.gif |
| 10/19/2003 11:26 AM | 1,745 | Prev-down.gif |
| 10/19/2003 11:26 AM | 1,783 | Prev-over.gif |
| 10/19/2003 11:26 AM | 1,762 | Prev.gif |
| 02/23/2004 10:31 PM | 2,072 | Print-down.gif |
| 02/23/2004 10:31 PM | 2,116 | Print-over.gif |
| 02/23/2004 10:30 PM | 2,113 | Print.gif |
| 02/23/2004 10:31 PM | 2,473 | release-down.gif |
| 02/23/2004 10:32 PM | 2,513 | release-over.gif |
| 02/23/2004 10:31 PM | 2,496 | release.gif |
| 04/04/2004 11:47 AM | 2,178 | RemData-down.gif |
| 04/04/2004 11:47 AM | 2,200 | RemData-over.gif |
| 04/04/2004 11:46 AM | 2,192 | RemData.gif |
| 03/05/2004 09:16 PM | 2,336 | Safety-down.gif |
| 03/05/2004 09:16 PM | 2,342 | Safety-over.gif |
| 03/05/2004 09:16 PM | 2,333 | Safety.gif |
| 12/17/2003 12:47 PM | 1,783 | Save-down.gif |
| 12/17/2003 12:48 PM | 1,847 | Save-over.gif |
| 12/17/2003 12:48 PM | 1,841 | Save.gif |
| 12/17/2003 02:49 PM | 2,442 | SaveFD-down.gif |
| 12/17/2003 02:49 PM | 3,042 | SaveFD-over.gif |
| 12/17/2003 02:49 PM | 2,418 | SaveFD.gif |
| 12/17/2003 02:49 PM | 2,395 | SaveHD-down.gif |
| 12/17/2003 02:49 PM | 2,401 | SaveHD-over.gif |
| 12/17/2003 02:49 PM | 4,163 | School-over.gif |
| 02/26/2004 03:10 PM | 4,164 | School.gif |
| 10/07/2003 05:01 PM | 1,297 | Start-down.gif |
| 10/07/2003 05:01 PM | 1,319 | Start-over.gif |
| 10/07/2003 05:01 PM | 1,298 | Start.gif |
| 12/17/2003 05:12 PM | 1,336 | Step1-down.gif |
| 12/17/2003 05:12 PM | 1,343 | Step1-over.gif |
| 12/17/2003 05:12 PM | 1,331 | Step1.gif |
| 12/17/2003 05:12 PM | 1,344 | Step2-down.gif |
| 12/17/2003 05:12 PM | 1,349 | Step2-over.gif |
| 12/17/2003 05:12 PM | 1,342 | Step2.gif |
| 12/17/2003 05:12 PM | 1,340 | Step3-down.gif |
| 12/17/2003 05:12 PM | 1,349 | Step3-over.gif |
| 12/17/2003 05:12 PM | 1,332 | Step3.gif |
| 12/17/2003 05:12 PM | 1,335 | Step4-down.gif |
| 12/17/2003 05:12 PM | 1,340 | Step4-over.gif |
| 12/17/2003 05:12 PM | 1,341 | Step4.gif |
| 12/19/2003 10:21 AM | 1,347 | Step5-down.gif |
| 12/19/2003 10:21 AM | 1,348 | Step5-over.gif |
| 12/19/2003 10:21 AM | 1,338 | Step5.gif |
| 12/19/2003 10:21 AM | 1,356 | Step6-down.gif |
| 12/19/2003 10:21 AM | 1,359 | Step6-over.gif |
| 12/19/2003 10:21 AM | 1,347 | Step6.gif |
| 12/19/2003 10:21 AM | 1,343 | Step7-down.gif |
| 12/19/2003 10:21 AM | 1,336 | Step7-over.gif |
| 12/19/2003 10:21 AM | 1,334 | Step7.gif |
| 03/06/2004 11:34 AM | 365,056 | Thumbs.db |
| 02/23/2004 05:07 PM | 2,368 | viewPrint-down.gif |
| 02/23/2004 05:07 PM | 2,378 | viewPrint-over.gif |
| 02/23/2004 05:07 PM | 2,331 | viewPrint.gif |
| 120 File(s) | 614,923 bytes | |

Directory of C:\Share\DIGIKI˜1\DIGIKIDS\CDLoad\CD\Setup

| | | |
|---|---|---|
| 04/27/2004 05:27 AM | <DIR> | .. |
| 04/27/2004 05:27 AM | <DIR> | . |
| 09/24/2003 10:24 AM | 143,360 | AspEmail.dll |
| 03/07/2004 09:28 AM | 283 | Data.dat |
| 03/07/2004 09:28 AM | 283 | data.txt |
| 03/06/2004 12:01 AM | 9,040 | Distribution_Flyer.htm |
| 04/30/2004 02:22 PM | 12,843 | EmergFL.hta |
| 03/07/2004 09:28 AM | 23,153 | image1.jpg |
| 03/07/2004 09:28 AM | 23,035 | image2.jpg |
| 04/01/2004 06:35 AM | 7,607 | InstallFL.hta |
| 04/01/2004 06:36 AM | 7,070 | InstallHD.hta |
| 02/23/2004 03:19 PM | 9,536 | NCMEC_abductor_bio.rtf |
| 02/23/2004 03:20 PM | 10,515 | NCMEC_child_bio.rtf |
| 02/19/2004 05:38 PM | 8,968 | NCMEC_release.rtf |
| 12 File(s) | 255,693 bytes | |
| Total Files Listed: | | |
| 166 File(s) | 4,511,333 bytes | |
| 23 Dir(s) | 11,655,536,640 bytes free | |

1) A method for entering identification data of a person or pet, comprising the steps of:
forming personal information of said person or said pet;
forming picture images of said person or pet; and
combining said personal information and said picture images simultaneously.

2) A method for entering identification data of a person or pet as in claim 1 wherein combining said personal information and said picture images are on a RAM of a computer and not on any permanent computer storage.

3) A method for entering identification data of a person or pet as in claim 1 wherein said step forming said personal information includes the step of using intelligent character recognition.

4) A method for entering identification data of a person or pet as in claim 1, wherein said step of combining said picture images and said personal information includes the fail-safe step of erasing said RAM of said picture images and said personal information.

5) An apparatus for entering identification data of a person or pet, comprising:
a scanner for scanning personal information of said person or said pet;
a camera for recording picture images of said person or pet; and
an apparatus for combining said personal information and said picture images simultaneously.

6) An apparatus for entering identification data of a person or pet as in claim 5 wherein said combining said personal information and said picture images are on a RAM of a computer.

7) An apparatus for entering identification data of a person or pet as in claim 5 wherein said apparatus uses intelligent character recognition to form said personal information.

8) An apparatus for entering identification data of a person or pet as in claim 7, wherein said apparatus erases said RAM of said picture images and said personal information.

9) A method for forming an ID card, comprising the steps of:
forming personal information on said ID card;
forming a picture image on said ID card;
forming a software program on said ID card that will function independent of installation on a computer.

10) A method for forming an ID card as in claim 9, wherein said ID card is a CD-ROM.

11) A method for forming an ID card as in claim 9, wherein said ID card includes a program to send an e-mail.

12) A method for forming an ID card as in claim 9, wherein said ID card includes a program to update said personal information.

13) A method for forming an ID card as in claim 9, wherein said ID card includes a program to update said picture data.

14) An ID card to identify a person or pet, comprising:
personal information positioned on said ID card;
a picture image positioned on said ID card; and
forming a software program on said ID card that will function independent of installation on a computer.

15) An ID card to identify a person or pet as in claim 14, wherein said ID card is a CD-ROM.

16) An ID card to identify a person or pet as in claim 14, wherein said ID card includes a program to send an e-mail.

17) An ID card to identify a person or pet as in claim 14, wherein said ID card includes a program to update said personal information.

18) An ID card to identify a person or pet as in claim 14, wherein said ID card includes a program to update said picture data.

19) An ID card to identify a person or pet as in claim 14, wherein said ID card is a Universal Serial Bus (USB) key.
